(19) United States
(12) Patent Application Publication
(10) Pub. No.: US 2025/0386170 A1
(43) Pub. Date: Dec. 18, 2025

(54) WIRELESS UNDERWATER COMMUNICATION SYSTEMS AND METHODS

(71) Applicant: ZODIAC POOL CARE EUROPE, Belberaud (FR)

(72) Inventors: Mehdi Chafik, Tournefeuille (FR); Olivier Cam, Toulouse (FR)

(73) Assignee: ZODIAC POOL CARE EUROPE, Belberaud (FR)

(21) Appl. No.: 19/233,043

(22) Filed: Jun. 10, 2025

Related U.S. Application Data
(60) Provisional application No. 63/658,935, filed on Jun. 12, 2024.

(51) Int. Cl. H04W 4/38; E04H 4/16; H04W 4/029

(52) U.S. Cl. CPC H04W 4/38; E04H 4/1654; H04W 4/029

(57) ABSTRACT

A self-propelled pool cleaner may be operable in a swimming pool or spa. The self-propelled pool cleaner may be capable of transmitting wireless signals beyond a boundary of the pool or spa when the pool cleaner is in close proximity to and/or is in contact with a solid surface or structure within the pool or spa. A method of communicating between the self-propelled pool cleaner and an external device may include contacting with a solid surface of a pool or spa and/or positioning the self-propelled pool cleaner within close proximity to the solid surface.

### REFERENCE TO RELATED APPLICATION

This application claims the benefit of and priority to U.S. Provisional Patent Application No. 63/658,935, filed on Jun. 12, 2024, and entitled WIRELESS UNDERWATER COMMUNICATION SYSTEMS AND METHODS, the content of which is hereby incorporated by reference in its entirety.

### FIELD OF THE INVENTION

The invention relates to water-containing vessels such as swimming pools and spas and more particularly, although not necessarily exclusively, to systems and methods for underwater communication.

### BACKGROUND OF THE INVENTION

Swimming pools, spas, and other water-containing vessels may include various equipment or components in or within water of the pool. As examples, cleaning devices capable of autonomous or self-propelled movement may be provided within the pool or spa, with the most common of these devices being pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. While some equipment, such as some pool cleaners, include cabling or cords extending from the pool cleaner (e.g., to receive power from an external source, communicate with a transmission relay, etc.), other equipment may be wireless and omit such cabling. However, wireless signals are rapidly absorbed by water of the pool, making it difficult for devices outside of the pool or spa to send and/or receive transmissions from equipment within the pool or spa.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool cleaner is configured to communicate wirelessly underwater via long range (LoRa) radio frequency communication.

According to some embodiments, a pool cleaner includes a communication module configured to wirelessly communicate with an external device using a LoRa communication technique.

According to various embodiments, a pool system includes a pool cleaner and an external electronic device. The pool cleaner and the external electronic device are configured to communicate using a LoRa communication technique at least while the pool cleaner is submerged within a pool or spa.

According to some embodiments, a pool cleaner may be configured to wirelessly communicate with an external device by physically contacting a surface of a pool or spa.

According to certain embodiments, a pool cleaner may be configured to wirelessly communicate with an external device by maintaining permanent and/or intermittent contact with a solid surface of a pool or spa.

According to various embodiments, a pool cleaner may be configured to wirelessly communicate with an external device using wireless signals that propagate through a solid volume at least partially surrounding a pool or spa.

According to some embodiments, a pool cleaner includes a contacting device, and the contacting device may be configured to (i) contact a solid surface of a pool or spa or be within a predefined proximity of the solid surface and (ii) transmit and/or receive a wireless signal through the solid surface while contacting the solid surface or being within the predefined proximity.

According to certain embodiments, a pool system includes a pool cleaner and an external electronic device, and the pool cleaner and the external electronic device are configured to wirelessly communicate when the pool cleaner is in contact with a solid surface of a pool or spa.

According to some embodiments, a pool system includes a pool cleaner and an external electronic device. The pool cleaner and the external electronic device may be configured to wirelessly communicate through a solid surface of the pool or spa when the pool cleaner is in contact with the solid surface of a pool or spa.

According to certain embodiments, a pool system includes a pool cleaner and an external electronic device, and the pool cleaner and the external electronic device are configured to wirelessly communicate through a solid volume at least partially surrounding a pool or spa.

According to various embodiments, a method includes establishing wireless communication between a pool cleaner and an external device using LoRa communication.

According to some embodiments, a method includes causing a pool cleaner to wirelessly communicate with an external device based on contact between the pool cleaner and a solid surface of a pool or spa.

According to various embodiments, a method includes causing a pool cleaner to wirelessly communicate with an external device through a solid volume at least partially surrounding a pool or spa.

According to certain embodiments, a method includes detecting water of a pool or spa by (i) determining a characteristic of a first LoRa signal to and/or from a pool cleaner while the pool cleaner is at a first location, wherein the first location is out of water, (ii) determining a characteristic of a second LoRa signal to and/or from the pool cleaner while the pool cleaner is at a second location different from the first location, and (iii) detecting water at the second location based on the characteristic of the second LoRa signal being different from the characteristic of the first LoRa signal.

According to some embodiments, non-transitory computer readable storage medium may include a plurality of instructions executable by one or more processors, which, when executed on the one or more processors, cause the one or more processors to perform actions including causing a communication module of a pool cleaner to wirelessly communicate with an external electronic device using LoRa communication at least while the pool cleaner is submerged within water of a pool or spa.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

### DETAILED DESCRIPTION

Described herein are systems and methods for improved communication with a pool cleaner, and in particular improved wireless communication with a pool cleaner. As used herein, “communication” may refer to sending and/or receiving information unless explicitly stated otherwise. Moreover, “communication” as used herein refers to an active or intended exchange of information or data. In certain embodiments, the systems and methods described herein provide improved communication at least while the pool cleaner is submerged within a pool or spa, and in other embodiments, may further provide improved communication while the pool cleaner is out of water of the pool or spa. In some embodiments, pool cleaners described herein may be capable of transmitting wireless signals beyond a boundary of the pool or spa when the pool cleaner is in close proximity to and/or is in contact with a solid surface or structure within the pool or spa.

In certain embodiments, the systems and methods described herein may include communication with an external electronic device based on contact with a solid surface of a pool or spa and/or the pool cleaner being within close proximity (e.g., within a predefined distance) to the solid surface. The solid surface may be various solid surfaces of the pool or spa as desired, such as but not limited to a pool floor, a pool wall, a step, a submerged structure, a bench, a shelf, combinations thereof, and/or as otherwise desired. In some embodiments, the systems and methods described herein may include wirelessly communication with the external electronic device with permanent and/or intermittent contact with the solid surface within the pool or spa. In various embodiments, by maintaining physical contact (permanent and/or intermittent) with the solid surface, the pool cleaner (or a communication device/module on the pool cleaner) may transmit wireless signals which propagate through a solid volume at least partially surrounding the pool and reach the external electronic device. In certain embodiments, the external electronic device may similarly communicate with the pool cleaner when the pool cleaner is in contact with (and/or in close proximity to) the solid surface. In some embodiments, a contacting device of the pool cleaner configured to contact and/or be in proximity to the solid surface may be movable relative to the pool cleaner, although in other embodiments the contacting device may be fixed.

Additionally, or alternatively, in some embodiments, the systems and methods described herein utilize radio frequency wireless communication, and in certain embodiments the systems and methods described herein utilize long range (LoRa) communication and/or LoRa technology. LoRa is a radiofrequency physical (physical layer) communication technology or technique, with low power consumption over long distances and is based on a modulation technique, particularly spread spectrum modulation techniques. In certain embodiments. LoRa communication between the pool cleaner and an external electronic device may be direct LoRa communication (e.g., no network servers or gateways are required), while in other embodiments the LoRa communication may be a LoRaWAN network protocol. Communication between the pool cleaner and external electronic device using LoRa communication may allow for wireless communication at least while the pool cleaner is submerged. Optionally, LoRa communication may be utilized for various sensing and/or detection of various characteristics of the pool system. As a non-limiting example. LoRa communication may be utilized to detect a presence of water based on a difference in LoRa signal characteristic(s) (e.g., compared to a characteristic of LoRa signal to and/or from the pool cleaner when the pool cleaner is out of water). Various other controls and/or methods may be implemented using LoRa communication as desired.

Compared to traditional communication approaches utilizing physical cables or other wireless communication, the systems and methods described herein may provide wireless communication between the pool cleaner and an external electronic device at least while the pool cleaner is submerged and while minimizing the effects of water on the wireless signals. In certain embodiments, LoRa communication may have specific frequencies and/or spreadability which allows for the wireless signals to penetrate the solid surfaces and/or solid volume of the pool. Various other benefits and advantages may be realized with the systems, devices, and methods provided herein, and the aforementioned advantages should not be considered limiting.

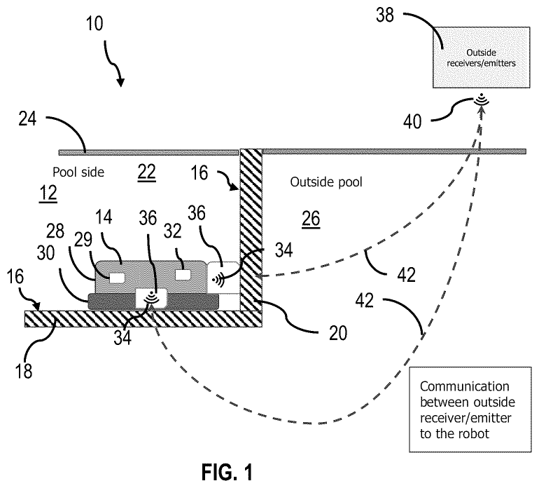

FIG. 1 illustrates an example of a pool system 10 according to embodiments. The pool system 10 generally includes a pool or spa (hereinafter “pool 12”) and a self-propelled pool cleaner 14.

The pool 12 may have various shapes, sizes, and/or profiles as desired, but generally includes one or more solid surfaces 16, such as but not limited to a floor 18 and/or one or more walls 20. Solid surfaces 16 within the pool 12 may additionally or alternatively include other features within the pool 12, such as, but not limited to, one or more steps, a bench, a sun shelf, a submerged structure, combinations thereof, and/or as other surfaces or structures as desired. Solid surfaces 16 within the pool 12 may have various shapes, sizes, profiles, and orientations as desired. As such, the particular solid surfaces 16 illustrated in FIG. 1 should not be considered limiting on the disclosure.

Water 22 within the pool 12 may be provided at various levels as desired and generally defines a waterline 24. In certain embodiments, a solid volume 26 at least partially surrounds the pool 12. The solid volume 26 may be various materials or combinations of materials at least partially surrounding the pool 12, such as but not limited to dirt, concrete, combinations thereof, and/or as otherwise desired.

The pool cleaner 14 generally includes a body 28 and a communication module 32.

The communication module 32 may be provided on and/or within the pool cleaner 14 as desired. As such, the particular location of the communication module 32 on the body 28 as illustrated in FIG. 1 should not be considered limiting. In one non-limiting example, the communication module 32 may be housed at least partially within the body 28. Moreover, the number of communication modules 32 illustrated should not be considered limiting, and in other embodiments, a plurality of communication modules 32 may be utilized in various arrangements on and/or within the pool cleaner 14 as desired.

The communication module 32 may be various systems or mechanisms enabling at least wireless communication 34 for the pool cleaner 14. In some non-limiting examples, the communication module 32 is a radio frequency (RF) communication module enabling wireless RF communication 32. In one non-limiting example, the wireless communication enabled by the communication module 32 may be LoRa communication for the pool cleaner 14, and the communication module 32 is a LoRa communication module 32. As discussed in detail below, in various embodiments, the communication module 32 may enable wireless communication for the pool cleaner 14 at least while the pool cleaner 14 is submerged within the pool 12 (e.g., as illustrated in FIG. 1).

Optionally, in addition to RF wireless communication, particularly LoRa communication, the communication module 32 may enable supplemental wired and/or wireless communication for the pool cleaner 14 as desired. As non-limiting examples, supplemental communication enabled by the communication module 32 may include, but is not limited to, wired communication and/or wireless communication (e.g., near field, cellular. Wi-Fi, Bluetooth®. Bluetooth Low Energy (BLE), cloud-based communication etc.).

In some embodiments, and as illustrated in FIG. 1, the pool cleaner 14 optionally includes one or more contacting devices 36 for further facilitating wireless communication for the pool cleaner 14. In various embodiments, the one or more contacting devices 36 may be configured to physically contact and/or be within a predefined distance or proximity to one or more of the solid surfaces 16 of the pool 12. The number of contacting devices 36 should not be considered limiting, and thus while two contacting devices 36 are illustrated in FIG. 1, in other embodiments, a single contacting device 36 may be utilized and/or more than two contacting devices 36 may be utilized. Moreover, while the two contacting devices 36 are illustrates as contacting and/or positioning proximate to different solid surfaces 16 (e.g., the floor 18 and the wall 20), in other embodiments, a plurality of contacting devices 36 may be arranged to contact and/or be positioned proximate to a same solid surface 16.

The one or more contacting devices 36 may be provided at various locations on the body 28 as desired, and the particular locations illustrated should not be considered limiting. In embodiments with a plurality of contacting devices 36, the pool cleaner 14 optionally includes various arrangements of the contacting devices 36 such that the pool cleaner 14 may contact solid surfaces 16 at a variety of orientations relative to the pool cleaner 14.

In some embodiments, the one or more contacting devices 36 may be fixed and/or unmoving on the pool cleaner 14. In such embodiments, the one or more contacting devices 36 may be supported on and/or attached to the pool cleaner 14 using various techniques or mechanisms as desired, such as but not limited to mechanical fasteners, magnets, snap-fit connections, clips, clasps, friction fit connections, molding, adhesives, combinations thereof, and/or as otherwise desired.

Additionally, or alternatively, the one or more contacting devices 36 may be movable and/or adjustable relative to the pool cleaner 14 using various mechanisms or systems as desired. As non-limiting examples, the one or more contacting devices 36 may be pivotable, rotatable, slidable, tiltable, and/or otherwise movable and/or adjustable as desired. In such embodiments, various types of actuators may be utilized to selectively position and/or move the contacting devices 36 relative to the pool cleaner 14, such as but not limited to mechanical actuators, hydraulic actuators, pneumatic actuators, electric actuators, piezoelectric actuators, electromagnetic actuators, linear actuators, rotary actuators, electro-mechanical actuators, solenoids, springs, elastic materials, combinations thereof, and/or as otherwise desired.

In certain embodiments, adjustable contacting devices 36 may allow for reorientation and/or positioning of the one or more contacting devices 36 (e.g., to change an orientation and/or position relative to the solid surfaces 16). Additionally. or alternatively, movable contacting devices 36 may allow for selective storage and/or deployment of the contacting devices 36 as desired. As a non-limiting example, the one or more contacting devices 36 may be retractable into, onto, and/or under the pool cleaner 14 when not in use and/or when the pool cleaner 14 is not wirelessly communicating, and may be deployed (e.g., as illustrated in FIG. 1) for wireless communication. In non-limiting examples, the one or more contacting devices 36 may be positionable between a stowed configuration, in which the one or more contacting devices 36 may be at least partially within the pool cleaner 14 and/or at a spaced apart distance relative to a solid surface 16, and a deployed configuration, in which the one or more contacting devices 36 may be at a reduced distance relative to the solid surface 16 (i.e., closer to the solid surface 16 compared to the stowed configuration). Other movement of the one or more contacting devices 36 may be implemented as desired.

In various embodiments, the pool cleaner 14 includes an onboard controller or control system 29, which may include one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In addition to the communications module 32, the pool cleaner 14 may include various features such that the pool cleaner 14 may perform various cleaning operations within the pool 12. As non-limiting examples, the pool cleaner 14 may include additional features or combinations of features as desired such as one or more cleaning devices (including but not limited to a scrubber brush), one or more motive elements 14, a motor, a pump, a filter, combinations thereof, and/or various other features or combinations of features may be provided on and/or within the pool cleaner 14 as desired. The one or more motive elements 30 may be various suitable devices for mechanisms enabling movement of the pool cleaner 14 and/or proximate to a surface of the pool 12. As non-limiting examples, the one or more motive elements 30 may be wheels, rollers, tracks, feet, combinations thereof, and/or as otherwise desired. Optionally, the pool cleaner 14 includes an on-board power source, such as but not limited to one or more on-board batteries. In certain embodiments, and as illustrated in FIG. 1, the pool cleaner 14 may be a wireless pool cleaner omitting external cabling or cords connecting the pool cleaner 14 to other devices. However, in other embodiments, the pool cleaner 14 may be a corded pool cleaner. Non-limiting examples of pool cleaners 14 may include those described in U.S. Pat. Nos. 10,316,534, 9,488,154, 8,578,538, and U.S. Patent Publication No. 2014/0303810, all of which are hereby incorporated by reference in their entireties.

In various embodiments, and as illustrated in FIG. 1, the pool system 10 optionally includes one or more electronic devices 38 which are external and/or outside of the pool 12. The electronic devices 38 may be various devices or combinations of devices as desired, such as but not limited to other pool equipment, an automation system, receivers, emitters, a gateway, an accessory, a node, user devices such as a smart phone and/or a remote control, combinations thereof, and/or as otherwise desired.

In certain embodiments, the one or more electronic devices 38 include various systems or mechanisms enabling wireless communication 40 with the pool cleaner 14, such as but not limited to RF wireless communication, such as but not limited to LoRa communication. The particular type, location, and number of electronic devices 38 should not be considered limiting on the disclosure. In embodiments where the one or more electronic devices 38 is a gateway, the gateway may be a wireless gateway (e.g., Wi-Fi) that facilities cloud-based communication. In some embodiments, the system may be capable of communicating with one or more electronic devices 38 that are a user device such as a smart phone and/or a physical remote control.

In some embodiments, and as illustrated in FIG. 1, the pool cleaner 14 may wirelessly communicate (e.g., via LoRa communication) with the one or more electronic devices 38 at least while the pool cleaner 14 is submerged within the pool 12.

Optionally, the pool cleaner 14 may wirelessly transmit and/or receive signals by contacting a solid surface 16 of the pool 12 and/or being in close proximity to the solid surface 16. As a non-limiting example, the pool cleaner 14 may communicate with the one or more electronic devices 38 by causing the one or more contacting devices 36 to contact one or more solid surfaces 16 of the pool 12 and/or to be in close proximity to one or more solid surfaces 16 of the pool 12.

In certain embodiments, the pool cleaner 14 (e.g., via the controller) may cause the one or more contacting devices 36 to deploy and/or to move into permanent and/or intermittent physical contact with the solid surface(s) 16. In some embodiments, by maintaining permanent and/or intermittent physical contact with the solid surface(s) 16, the pool cleaner 14 may wirelessly communicate with signals that propagate through the solid surface(s) 16. In certain embodiments, by maintaining permanent and/or intermittent physical contact with the solid surface(s) 16, the pool cleaner 14 may wirelessly communicate with signals that propagate through the solid volume 26 (represented by dashed lines 42) to and/or from the one or more electronic devices 38. Optionally, the one or more electronic devices 38 may wirelessly communicate with the pool cleaner 14 when the pool cleaner 14 is in contact with and/or in proximity to the solid surface(s) 16.

As mentioned, the pool cleaner 14 may maintain permanent physical contact or intermittent contact with the solid surfaces 16 for wireless communication. In embodiments with intermittent contact, the contact may be at predefined or irregular intervals as desired. As a non-limiting example, the pool cleaner 14 may communicate wirelessly each time the pool cleaner 14 contacts the wall, based on contact within a certain time period, combinations thereof, and/or as otherwise desired.

The information wirelessly communicated (e.g., via LoRa and/or physical contact/proximity to a solid surface 16) between the pool cleaner 14 and one or more electronic devices 38 may be various information as desired. The communication between the pool cleaner 14 and one or more electronic devices 38 may be bi-directional or unidirectional as desired.

As a non-limiting example, the information may include instructions from an external device for controlling operation of the pool cleaner 14, such as but not limited to instructions to initiate a cleaning cycle by the pool cleaner 14, to stop a cleaning cycle by the pool cleaner 14, to cause the pool cleaner 14 move to a certain area of the pool 12 such as proximate to a wall, to add time to a cleaning cycle of the pool cleaner 14, to instruct the pool cleaner 14 to dock at a docking station, to instruct the pool cleaner 14 to climb a wall, to provide navigation information to the pool cleaner 14, combinations thereof, and/or as otherwise desired.

As another non-limiting example, the information may include information received from a user and/or other source that is provided to the pool cleaner 14, such as but not limited to weather information, a scheduled start time for a cleaning cycle, a swimming schedule for the user, location information, information from other pool equipment, combinations thereof, and/or as otherwise desired.

As another non-limiting example, the information may include sensed information obtained from a sensor onboard the pool cleaner 14 and/or sensed information from another source or sensor that is provided to the pool cleaner 14.

As another non-limiting example, the information may include information about the pool 14 and/or operation of the pool cleaner 14 as detected by the pool cleaner 14, such as but not limited to a cleaning path of the pool cleaner 14, a cycle time of the pool cleaner 14, debris detected by the pool cleaner 14, a filter status of the pool cleaner 14, a pump status of the pool cleaner 14, a water characteristic as detected by the pool cleaner, combinations thereof, and/or other information as desired.

Other information may be provided as desired, and the aforementioned examples should not be considered limiting.

In some embodiments, if the pool cleaner 14 does not receive a signal from the one or more electronic devices 38 (e.g., within a specified period of time), the pool cleaner 14 may take a predetermined action. Predetermined actions may be implemented to attempt to improve communication and/or receive a signal, and/or may be implemented as otherwise desired. Non-limiting examples of predetermined actions may include climbing a wall, moving to a predetermined area within a pool such as within close proximity to a wall, reorienting the pool cleaner 14, changing which contacting device 36 of a plurality of contacting devices 36 in contact or close proximity to the solid surface, stowing, deploying, and/or adjusting the one or more contacting devices 36, combinations thereof, and/or as otherwise desired.

Optionally, in addition to establishing communication between the pool cleaner 14 and the one or more electronic devices 38, the wireless communication, such as but not limited to LoRa communication, may be utilized to sense or detect information about the pool 12 and/or the pool cleaner 14. As a non-limiting example, the LoRa communication may be utilized for water detection by the pool cleaner 14. In this non-limiting example, the controller of the pool cleaner may determine a characteristic of a first LoRa signal to and/or from the pool cleaner 14, such as but not limited to a strength or power of the signal, while the pool cleaner 14 is at a first location out of water. The controller may determine a characteristic of a second LoRa signal to and/or from the pool cleaner 14 while the pool cleaner 14 is at a second location different from the first location.

In certain embodiments, the controller may compare the characteristic of the first LoRa signal with the characteristic of the second LoRa signal and determine an environment of the pool cleaner 14 based on the comparison. As a non-limiting example, the controller may detect water at the second location based on the characteristic of the second LoRa signal being different from the characteristic of the first LoRa signal, and may detect a lack of water, or out of water environment, at the second location based on the characteristics being the same. Other controls or detections may be implemented based on the LoRa communication as desired, and the aforementioned example should not be considered limiting.

Various other benefits and advantages may be realized with the systems, devices, and methods provided herein, and the aforementioned advantages should not be considered limiting.

Exemplary concepts or combinations of features of the invention may include:
A. A pool cleaner configured to communicate wirelessly underwater via long range (LoRa) radio frequency communication.
B. A pool cleaner comprising a communication module configured to wirelessly communicate with an external device using a LoRa communication technique.
C. A pool system comprising:
   a. a pool cleaner; and
   b. an external electronic device, wherein the pool cleaner and the external electronic device are configured to communicate using a LoRa communication technique at least while the pool cleaner is submerged within a pool or spa.
D. A pool cleaner configured to wirelessly communicate with an external device by physically contacting a surface of a pool or spa.
E. The pool cleaner of the preceding statement, where the pool cleaner wirelessly communicates with the external device by transmitting signals through the surface using LoRa communication.
F. A pool cleaner configured to wirelessly communicate with an external device by maintaining permanent and/or intermittent contact with a solid surface of a pool or spa.
G. The pool cleaner of the preceding statement, where the pool cleaner wirelessly communicates with the external device by transmitting signals through the solid surface using LoRa communication.
H. A pool cleaner configured to wirelessly communicate with an external device using wireless signals that propagate through a solid volume at least partially surrounding a pool or spa.
I. The pool cleaner of the preceding statement, where the pool cleaner wirelessly communicates with the external device by transmitting signals through the solid volume using LoRa communication.
J. A pool cleaner comprising a contacting device, wherein the contacting device is configured to (i) contact a solid surface of a pool or spa or be within a predefined proximity of the solid surface and (ii) transmit and/or receive a wireless signal through the solid surface while contacting the solid surface or being within the predefined proximity.
K. The pool cleaner of the preceding statement, where the pool cleaner transmits and/or receives the wireless signal through the solid surface using LoRa communication.
L. A pool system comprising:
   a. a pool cleaner; and
   b. an external electronic device, wherein the pool cleaner and the external electronic device are configured to wirelessly communicate when the pool cleaner is in contact with a solid surface of a pool or spa.
M. The pool cleaner of the preceding statement, where the pool cleaner wirelessly communicates with the electronic device through the solid surface using LoRa communication.
N. A pool system comprising:
   a. a pool cleaner; and
   b. an external electronic device, wherein the pool cleaner and the external electronic device are configured to wirelessly communicate through a solid surface of the pool or spa when the pool cleaner is in contact with the solid surface of a pool or spa.
O. The pool system of the preceding statement, where the pool cleaner wirelessly communicates with the electronic device through the solid surface using LoRa communication.
P. A pool system comprising:
   a. a pool cleaner; and
   b. an external electronic device, wherein the pool cleaner and the external electronic device are configured to wirelessly communicate through a solid volume at least partially surrounding a pool or spa.
Q. The pool system of the preceding statement, where the pool cleaner wirelessly communicates with the electronic device through the solid volume using LoRa communication.
R. The pool system or cleaner of any preceding or subsequent statements or combinations of statements, wherein LoRa communication comprises sending and/or receiving wireless communication.
S. A method comprising establishing wireless communication between a pool cleaner and an external device using LoRa communication.
T. A method comprising causing a pool cleaner to wirelessly communicate with an external device based on contact between the pool cleaner and a solid surface of a pool or spa.
U. A method comprising causing a pool cleaner to wirelessly communicate with an external device through a solid volume at least partially surrounding a pool or spa.
V. A method comprising detecting water of a pool or spa by:
   a. determining a characteristic of a first LoRa signal to and/or from a pool cleaner while the pool cleaner is at a first location, wherein the first location is out of water;
   b. determining a characteristic of a second LoRa signal to and/or from the pool cleaner while the pool cleaner is at a second location different from the first location; and
   c. detecting water at the second location based on the characteristic of the second LoRa signal being different from the characteristic of the first LoRa signal.
W. Non-transitory computer readable storage medium comprising a plurality of instructions executable by one or more processors, which, when executed on the one or more processors, cause the one or more processors to perform actions comprising causing a communication module of a pool cleaner to wirelessly communicate with an external electronic device using LoRa communication at least while the pool cleaner is submerged within water of a pool or spa.
X. The pool system, cleaner, or method of any preceding or subsequent statements or combinations of statements, wherein the contacting device is retractable and/or movable on a body of the pool cleaner.
Y. The pool system, cleaner, or method of any preceding or subsequent statements or combinations of statements, wherein the contacting device is fixed on the pool cleaner.
Z. The pool system, cleaner, or method of any preceding or subsequent statements or combinations of statements, wherein the wireless signals that propagate through a solid volume at least partially surrounding a pool or spa and/or the wireless signals through the solid surface are responsive to at least one of (i) contact between the pool cleaner and a solid surface of the pool or spa and/or (ii) the pool cleaner being within a predefined proximity of the solid surface.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A self-propelled pool cleaner comprising a communication module configured to wirelessly communicate with an external device using wireless signals that propagate through a solid volume at least partially surrounding a pool or spa.

2. The self-propelled pool cleaner of claim 1, wherein the communication module is configured to wirelessly communicate using long range (LoRa) radio frequency communication.

3. The self-propelled pool cleaner of claim 1, wherein the self-propelled pool cleaner is configured to wireless communicate by physically contacting a surface of the pool or spa.

4. The self-propelled pool cleaner of claim 1, wherein the self-propelled pool cleaner is configured to wireless communicate by maintaining permanent with a solid surface of the pool or spa.

5. The self-propelled pool cleaner of claim 1, wherein the self-propelled pool cleaner is configured to wireless communicate by intermittent contact with a solid surface of the pool or spa.

6. The self-propelled pool cleaner of claim 1, further comprising a contacting device, wherein the contacting device is configured to (i) contact a solid surface of the pool or spa or be within a predefined proximity of the solid surface and (ii) transmit and/or receive a wireless signal through the solid surface while contacting the solid surface or being within the predefined proximity.

7. A pool system comprising:
the self-propelled pool cleaner of claim 1; and
an external electronic device, wherein the external device comprises a piece of pool equipment.

8. A self-propelled pool cleaner comprising a contacting device, wherein the contacting device is configured to (i) contact a solid surface of a pool or spa or be within a predefined proximity of the solid surface and (ii) transmit and/or receive a wireless signal through the solid surface while contacting the solid surface or being within the predefined proximity.

9. The self-propelled pool cleaner of claim 8, wherein the contacting device movable on a body of the pool cleaner.

10. The self-propelled pool cleaner of claim 9, wherein the contacting device is adjustable between a stowed configuration and a deployed configuration relative to the body of the pool cleaner.

11. The self-propelled pool cleaner of claim 8, the contacting device is fixed on the pool cleaner.

12. The self-propelled pool cleaner of claim 8, wherein the wireless signal is a LoRa signal.

13. The self-propelled pool cleaner of claim 8, wherein the contacting device is configured to wireless communicate by maintaining permanent with the solid surface of the pool or spa.

14. The self-propelled pool cleaner of claim 8, wherein the self-propelled pool cleaner is configured to wireless communicate by intermittent contact with the solid surface of the pool or spa.

15. The self-propelled pool cleaner of claim 8, wherein the contacting device is a first contacting device, wherein the self-propelled pool cleaner comprises a second contacting device, and wherein the first contacting device and the second contacting device are on a same side of the self-propelled pool cleaner.

16. The self-propelled pool cleaner of claim 8, wherein the contacting device is a first contacting device, wherein the self-propelled pool cleaner comprises a second contacting device, and wherein the first contacting device and the second contacting device are on different sides of the self-propelled pool cleaner.

17. A self-propelled pool cleaner comprising a controller and a communication module, wherein the self-propelled pool cleaner is configured to detect water of a pool or spa by:
determining a characteristic of a first LoRa signal to and/or from the self-propelled pool cleaner while the self-propelled pool cleaner is at a first location, wherein the first location is out of water;
determining a characteristic of a second LoRa signal to and/or from the self-propelled pool cleaner while the self-propelled pool cleaner is at a second location different from the first location; and
detecting water at the second location based on the characteristic of the second LoRa signal being different from the characteristic of the first LoRa signal.

18. The self-propelled pool cleaner of claim 17, further comprising a contacting device, wherein the contacting device is configured to (i) contact a solid surface or be within a predefined proximity of the solid surface and (ii) transmit and/or receive the first LoRa signal and/or the second LoRa signal through the solid surface while contacting the solid surface or being within the predefined proximity.

19. The self-propelled pool cleaner of claim 18, wherein the contacting device is movable on a body of the self-propelled pool cleaner.

20. The self-propelled pool cleaner of claim 18, wherein the contacting device is fixed on a body of the self-propelled pool cleaner.
